(19) United States
(12) Patent Application Publication
(10) Pub. No.: US 2016/0267498 A1
(43) Pub. Date: Sep. 15, 2016

(54) SYSTEMS AND METHODS FOR IDENTIFYING NEW USERS USING TREND ANALYSIS

(71) Applicant: Abhishek SUMAN, Bihar Sharif (IN)

(72) Inventor: Abhishek SUMAN, Bihar Sharif (IN)

(73) Assignee: Wipro Limited, Bangalore (IN)

(21) Appl. No.: 14/745,885

(22) Filed: Jun. 22, 2015

(30) Foreign Application Priority Data
Mar. 10, 2015 (IN) 1156/CHE/2015

(51) Int. Cl. G06Q 30/02

(52) U.S. Cl. CPC G06Q 30/0201; G06Q 50/01

(57) ABSTRACT

This disclosure relates to systems and methods for identifying new users using trend analysis. In one embodiment, a method for identifying potential users using machine learning is disclosed. The method may include receiving, via one or more hardware processors, existing user data for a business entity. The method may also include identifying, via the one or more hardware processors, using the existing user data, account information of existing users on one or more social media networks. The method may further include configuring, via the one or more hardware processors, one or more social media listeners to extract, using the account information of the existing users, social media data associated with the existing users from the one or more social media networks.

### PRIORITY CLAIM

This U.S. patent application claims priority under 35 U.S.C. §119 to: Indian Application No. 1156/CHE/2015, filed on Mar. 10, 2015. The aforementioned application is incorporated herein by reference in its entirety.

### TECHNICAL FIELD

This disclosure relates generally to data mining, and more particularly to systems and methods for identifying new users using trend analysis.

### BACKGROUND

Conventional methods of reaching out to new potential users include blanket advertising. When individual contact is made, companies typically contact users at random (e.g., cold calling) or using antiquated bulk mailing lists. These methods may result in a low success rate when contacting potential users. For example, bulk mailing lists may produce a pool of potential users that is overly broad. Further, these methods may not update frequently enough to be of use in rapidly evolving user information. For example, many individuals have public profiles on social media networks with individualized public information.

### SUMMARY

In one embodiment, a method for identifying potential users using machine learning is disclosed. The method may include receiving, via one or more hardware processors, existing user data for a business entity. The method may also include identifying, via the one or more hardware processors, using the existing user data, account information of existing users on one or more social media networks. The method may include configuring, via the one or more hardware processors, one or more social media listeners to extract, using the account information of the existing users, social media data associated with the existing users from the one or more social media networks. The method may include creating, via the one or more hardware processors, virtual profiles for the existing users based on the existing user data and the social media data associated with the existing users. The method may include extracting, by performing multidimensional trend analysis via the one or more hardware processors, one or more trends based on the virtual profiles and one or more requirements of the business entity. The method may include identifying, using a learning model implemented via the one or more hardware processors, based on the one or more extracted trends, new potential users using the social media networks.

In one embodiment, a non-transitory computer-readable medium storing computer-executable trend analysis instructions is disclosed. The instructions may include receiving, via one or more hardware processors, existing user data for a business entity; identifying, via the one or more hardware processors, using the existing user data, account information of existing users on one or more social media networks; configuring, via the one or more hardware processors, one or more social media listeners to extract, using the account information of the existing users, social media data associated with the existing users from the one or more social media networks; creating, via the one or more hardware processors, virtual profiles for the existing users based on the existing user data and the social media data associated with the existing users; extracting, by performing multidimensional trend analysis via the one or more hardware processors, one or more trends based on the virtual profiles and one or more requirements of the business entity; and identifying, using a learning model implemented via the one or more hardware processors, based on the one or more extracted trends, new potential users using the social media networks.

In one embodiment, a user trend analysis system is disclosed. The system may include one or more hardware processors and a computer-readable medium storing instructions that, when executed by the one or more hardware processors, cause the one or more hardware processors to perform operations. The operations may include receiving, via one or more hardware processors, existing user data for a business entity; identifying, via the one or more hardware processors, using the existing user data, account information of existing users on one or more social media networks; configuring, via the one or more hardware processors, one or more social media listeners to extract, using the account information of the existing users, social media data associated with the existing users from the one or more social media networks; creating, via the one or more hardware processors, virtual profiles for the existing users based on the existing user data and the social media data associated with the existing users; extracting, by performing multidimensional trend analysis via the one or more hardware processors, one or more trends based on the virtual profiles and one or more requirements of the business entity; and identifying, using a learning model implemented via the one or more hardware processors, based on the one or more extracted trends, new potential users using the social media networks.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary trend analysis system according to some embodiments of the present disclosure.

FIG. 2 is a flow diagram illustrating an exemplary trend analysis process in accordance with some embodiments of the present disclosure.

FIG. 3 is a flow diagram illustrating an exemplary update process in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

An entity needs to continually expand its user base in order to reach new clients to grow revenue. Also, services are more competitive over user than ever before. For example, services may race to reach new users efficiently by using a reasonable portion of their resources.

The Internet contains large stores of publicly available personal information. For example, message board comments, product reviews, and blog articles all convey information about an individual. Moreover, social networks have tied real identities to these individuals, so that actual people may be linked with individual public information. For example, user comments on a news article made using a particular social media account may use a person's real name. This individualized information may be useful in determining whether a person is likely use a service or product. For example, blog articles or social media posts may convey interests or behaviors.

However, because the data is scattered across thousands of websites and resources, capturing individual information effectively may prove to be difficult. Further, converting information into meaningful insights may need updated information to increase effectiveness. Disclosed embodiments may increases the number of users of an entity by taking into consideration the details of its existing users across social media and the Internet. Embodiments may find new potential user with that may have similar interests or behaviors.

Illustrative embodiments of the present disclosure are listed below. In one embodiment, a trend analysis system is disclosed. In another embodiment, a trend analysis process is disclosed. The system and method may enhance a customer base using trend analysis by classifying individuals, groups and communities of similar pattern in multidimensional approach (based on the requirements of a given entity) which can be potential target for extending customer base of that entity. The system and method may be used in combination or independently. For example, disclosed processes may be performed using different devices and systems. Disclosed systems may be used to perform other processes.

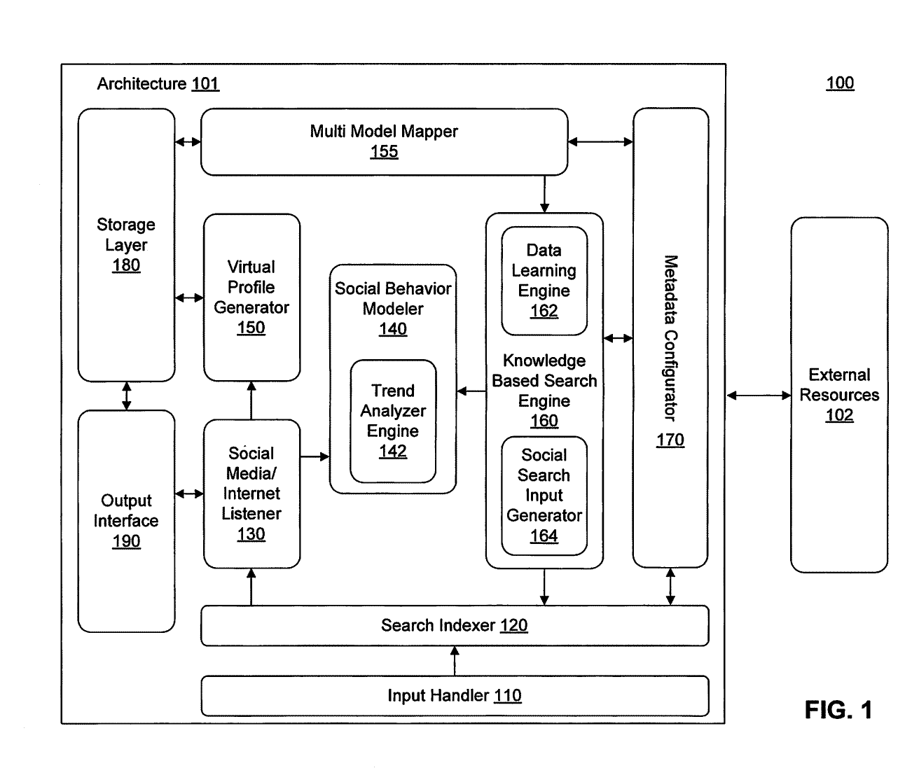

FIG. 1 illustrates an exemplary trend analysis system according to some embodiments of the present disclosure. System 100 may include architecture 101, which may be made of various processors or modules. The depicted functional blocks may be implemented using one or more hardware processors, such as application specific integrated circuits (ASICs). In other embodiments, the functional blocks may include hardware performing processes based on instructions. In other embodiments, the functional blocks may perform processes using software or virtualized hardware.

As depicted, architecture 101 may include input handler 110. Input handler 110 may enable architecture 101 to analyze the behavior of social entities present across social media services and internet websites. To perform a search over social media, input handler 110 may ingest identities into system 100. In an embodiment, input handler 110 may receive and format existing user information. The ingesting process may include parsing user records, formatting raw data, and storing the data. For example, input handler 110 may receive raw text, parse the text, synthesize the information, and format the information for usage (e.g., using XML).

Input handler 110 may have readers which may provide an interface to customer relations management systems of an organization via external resources 102. Input handler 110 may read each entry defined in connected customer relations management systems and give each entity (e.g., individualized information) to search indexer 120 for further processing.

Architecture 101 may also include search indexer 120. Search Indexer 120 may be responsible for connecting system 100 to social media sources, for example via the Internet, to extract social content broadcasted by social media entities. Social media entities may be referred to search indexer 120 by Input Handler 110. Search indexer may establish a pipeline between real-time social media sources and system 100. For example, search indexer 120 may utilize application programming interfaces (APIs), queries, or web crawling to provide social media information (e.g., posts, status updates, check-ins, photo uploads) in real-time. Search indexer may index the real-time data using tags, tries, or hash tables in a database (e.g., a graph database, NoSQL database). Search indexer 120 may enable system 100 to browse social media in real-time to capture content broadcasted across many social media services. The ingested data that is indexed for searching is configured using metadata configurator 170, which may decide how the indexing may be organized. For example, search indexer may ask metadata configurator 170 what indexing format should be used for the indexing process (e.g., name, location, company details, and/or other available details which may be stored by a customer relationship management system).

Architecture 101 may include internet listener 130. Internet listener 130 may connect directly with search indexer 120 to browse social media entities. Internet listener 130 may use custom built listeners over a distributed computing platform for capturing social media feeds. For example, internet listener 130 may include a plurality of listeners on social media networks that may capture individual user data (e.g., status updates, photo uploads) in real-time and store results in NoSQL-based storage. Listeners may be configured to capture the activity of these users over a defined duration in short intervals. The listeners may also scrape content from the Internet based on the provided social entity information from search indexer 120.

Architecture 101 may also include behavior modeler 140. System 100 may ingest large amounts of social media data feeds from distributed listeners of internet listener 130. The data feeds may be processed by behavior modeler 140 as a stream of continuous data. Behavior modeler 140 may analyze the stream in real-time to create models of identified behavior found inside the data. Behavior modeler may extract details such as, for example, interests of each social entity and preferred locations.

Behavior modeler 140 may include trend analyzer engine 142. In an embodiment, trend analyzer engine 142 may extract social trends after analyzing various social entities. Trend analyzer engine 142 may be responsible for extracting trends out of data sets. Trends may include the work industry of a group of individuals, age groups, and demographics, for example. Trend analyzer engine 142 may aid the understanding of trends for an organization when a larger number of customer relations management entries are contributing to same trend. For example, when a larger number of identified entities are contributing to a similar work industry, a trend may be true across an entire organization.

Architecture 101 may include virtual profile generator 150. Virtual profile generator may create virtual profiles for each identified individual in social media services. The virtual profile may be used to further understand an individual for multi-level mapping (e.g., by multi model mapper 155). Profiles may include details captured from internet listener 130 and social behavior modeler 140, such as real-time social media information, for example. Internet listener 130 may provide a direct, real-time feed to virtual profile generator 150 for virtual profile generation. Further details related to each identified profile may be captured by virtual profile generator 150 from social behavior modeler 140. For example, social behavior modeler 140 may be able to provide interests, trends, and behavior data.

Multi Model Mapper 155 may be a part of architecture 101. Multi model mapper 155 may collect data coming from sources, such as storage layer 180 and social behavior modeler 140. Multi model mapper 155 may create a map of social behavior using virtual profiles fetched from storage layer 180. Metadata configurator 170 may determine and provide the mapping, which can be configured and via received user preferences or automatically using predefined rules. The map may enrich virtual profiles with added details, such as social behavior. The map of multi model mapper 155 may also be stored in storage layer 180 for additional uses. Multi model mapper 155 may format the map for display via a web interface, such as a networked interface connected to output interface 190. The formatted map may provide detailed descriptions of profiles fetched from social media services.

Search engine 160 may provide query services in architecture 101. In an embodiment, search engine 160 may interact with behavior modeler 140 and multi model mapper 155 after the completion of processing on the input data set fetched from a customer relationship management system. Search engine 160 may interact to understand each and every social entity identified by the system. For example, search engine 160 may identify new social identities across social media services and the Internet which match the trends and criteria identified (e.g. the trends from trend analyzer engine 142). Search engine 160 may help find new profiles matching existing profiles provided by customer relationship management systems.

Search engine 160 may include data learning engine 162. Data learning engine 162 may automatically identify similarities between virtual profiles. For example, Data learning engine 162 may be a machine learning-based engine which may aid in processing and formatting fetched data in order to understand and find new profiles that have similarities. In an embodiment, data learning engine 162 may learn about the behavior, sentiment, interests, work industry, and various other features present in multi model mapper 155 and social behavior modeler 140 to find and tag new similar profiles. For example, search engine 160 may use an Apriori algorithm to mine profile data and learning associations between known user profiles (e.g., users provided by customer relations management systems). Metadata configurator 170 may provide instructions to data learning engine 162 instructing the engine on which features should be learned or limits on the level of learning the data learning engine 162 should perform.

Search engine 160 may include search input generator 164 for providing information to select new potential users. In an embodiment, once data learning engine 162 has completed processing given data, search input generator 164 may provide search instructions. For example, when data learning engine 162 has exhausted machine learning algorithms on known user information, search input generator 164 may instruct search indexer 120 with matching criteria to find new profiles. Search indexer 120 may search for profiles as instructed by search input generator 164 and redirect results (e.g., user profiles) to internet listener 130. Profiles may be collected by output interface 190 via internet listener 130 for further processing.

System 100 may include metadata configurator 170 to propagate configuration settings in architecture 101. In an embodiment, metadata configurator may receive, store, and institute operational settings for different components. Example settings may include a social media listener's duration of crawl, multi-model mapping details, and virtual profile formats. System 100 may implement the settings to alter or enhance the performance of the system based on the provided value. In an embodiment, metadata configurator 170 may be a configuration system which helps system 100 save or change settings values in order to configure the system performance based on the available inputs and the requirements.

Storage layer 180 may record data for use in system 100. In an embodiment, storage layer 180 may include networked storage hardware. For example, storage layer 180 may be a collection of hard disk drives. In another embodiment, storage layer 180 may be a cloud-base database. Many components of system 100 may provide useful data for the use of system 100. Storage layer 180 may capture and store these data points for other components to use. For example, internet listener 130 may gather relevant information, which storage layer 180 would place in memory and provide to trend analyzer engine 142 for analysis.

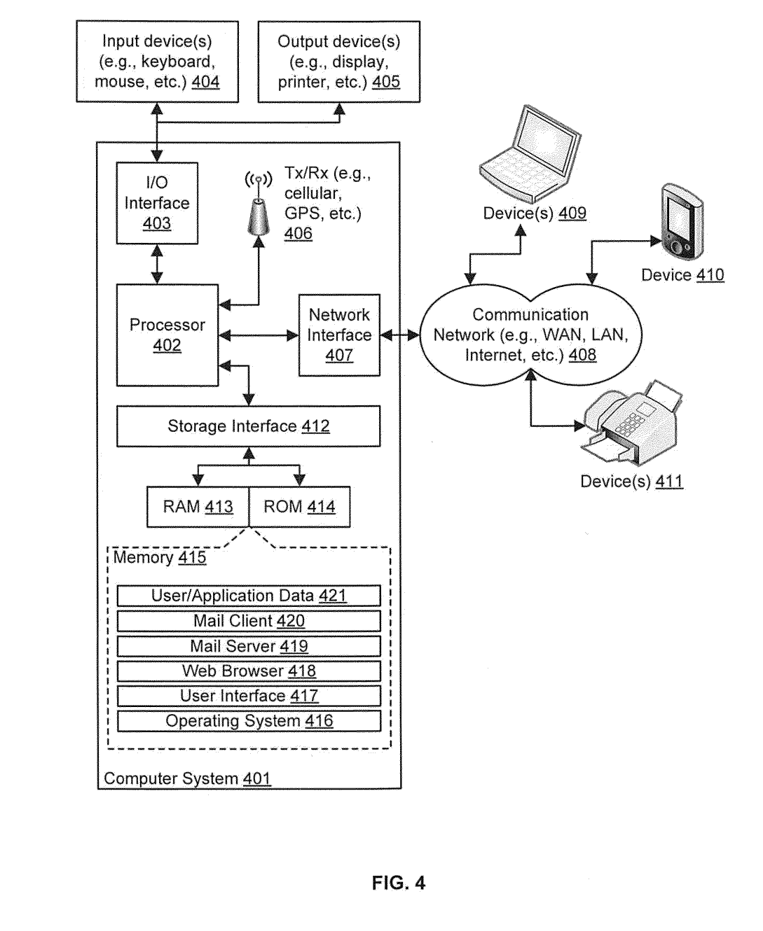

Storage layer 180 may interact with output interface 190. Storage layer 180 may need to provide data to external devices. For example, storage layer 180 may provide information for display on a monitor using output interface 190. Other external devices such as those described in FIG. 4 may receive data from storage layer 180 via output interface 190.

Output interface 190 may connect with external references. In an embodiment, output interface 190 may be a physical interface connection. For example, output interface 190 may be a USB, Ethernet, or Wi-Fi connection to other devices and/or networks. Output interface may provide results and intermediate results to third party system.

External resources 102 of system 100 may provide architecture 101 with additional capabilities. In an embodiment, system 100 may interact with external data sources for getting inputs into architecture 101. These interactions are happening using external resources 102. For example, external resources 102 may interface with networked data stores to provide auxiliary user information or trend analysis procedures. External resources may also collect output via details captured at output interface 190.

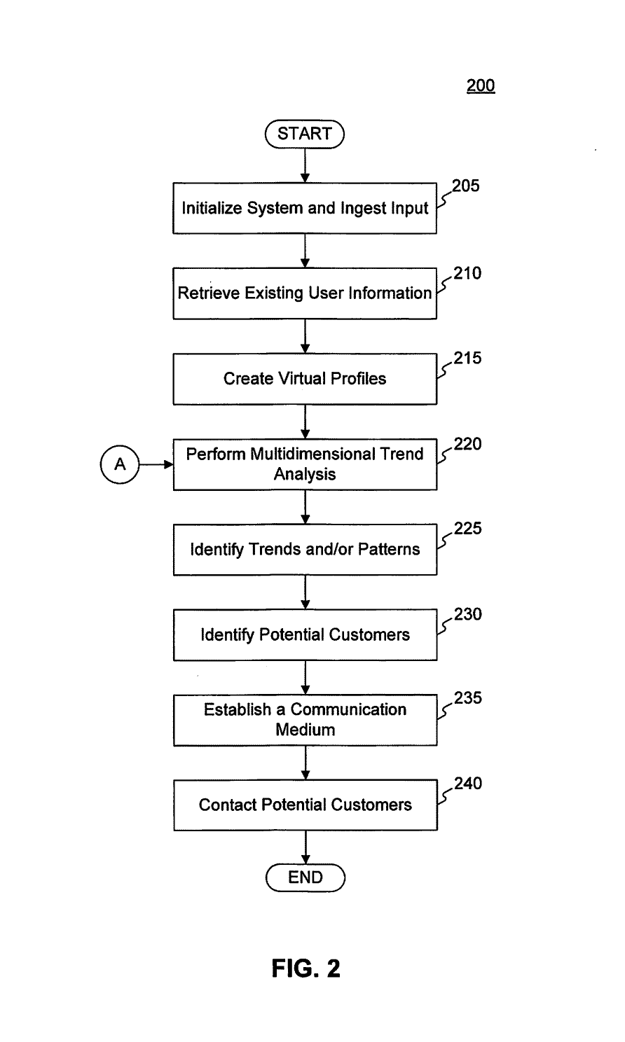

FIG. 2 is a flow diagram illustrating an exemplary trend analysis process in accordance with some embodiments of the present disclosure. The steps of process 200 are illustrated and listed in a particular order. However, this order is not meant to be limiting. For example, steps may be performed in other orders consistent with the disclosure. Further, various steps may be omitted in certain embodiments.

Process 200 may begin with step 205. In step 205, architecture 101 may perform initialization procedures and ingest input details. When system 100 has received or identified the required business entity subject to the pattern extraction analysis, existing customer relationship management systems or existing user base data may be received by system 100 via input handler 110. System 100 may pick these exposed entries and process them for further analysis in subsequent stages.

In step 210, system 100 may retrieve details of existing users by crawling social media and internet resources. In an embodiment, internet listener 130 may start real-time social media listeners to crawl social media and internet based on the provided details. For example, once the customer relationship management entries are ingested into system 100, search indexer 120 may assist in finding proper locations to search for these entries. The locations may be targeted based on the input data available across social media locations. Search indexer 120 may searches entries across social media services (e.g., status updates, posts, photo uploads, check-ins) and the Internet (e.g., websites, blogs, news articles, forums, message boards). Once the provided entry is identified in social media, a pipeline may be established between search indexer 120 and internet listener 130 to access the details.

Step 210 may also include configuring the listeners to capture details for a defined duration in short intervals and store it the system. After completion of processes performed by search indexer 120, pipelines may be established between the social media entries and system 100. Social media listeners of internet listener 130 may be configured to leverage these pipelines to extract data in real-time. The social media listeners may be configured to extract data over a fixed duration of time and/or over short intervals.

In an embodiment, step 210 may include adding and/or updating existing details as identified by the listeners in the given duration.—The extracted details of the identified users are stored inside Storage Layer module in form of NoSQL based storage system for efficient storage of unstructured data. There are various details which might change over time and requires updating on the existing data. This is done by repeated listening to same entries which can help the system to add or update existing details.

In step 215, virtual profile generator 150 may create a virtual profile for each of the identified users. In an embodiment, the virtual profiles of each identified users, their interest, behavior, qualities, work industry, address, and various other patterns whichever is publicly available. For example, a user's social media account may have posts geotagged with a certain location, submitted a certain time of day, or containing certain keywords. Virtual profile generator 150 may analyze data that is stored inside storage layer 180 to capture and extract details related to trends and profile generation. Virtual profile generator 150 may extract profile related details using social behavior modeler 140 (e.g., at step 220). In an embodiment, step 220 may include multi model mapper 155 tagging interests, behaviors, qualities, and/or other features related to each identified profile. These virtual profiles may be generated by virtual profile generator 150 and then stored inside storage layer 180.

In step 225, social behavior modeler 140 may identify trends and/or patterns in user profiles. In an embodiment, social behavior modeler may use multidimensional approach to analyze generate profiles based on requirements of an identified entity (e.g., a company, manufacturer, or service provider) to extract patterns. Social behavior modeler 140 may analyze profiles generated in virtual profile generator 150 for pattern or trend analysis. Once a pattern or trend is extracted by trend analyzer engine 142, the profile may be marked as corresponding to a particular trend category. Trend categories may be groups of users having similar trends or patterns present in their social media feed. The extraction of trends and patterns may be based on the requirements of the identified entity. When different requirements are provided to system 100, the analyses of trend analyzer engine 142 may result in different trends.

In step 230, search engine 160 may identify potential new users. In an embodiment, search engine 160 may initiate new searches across social media services and the Internet for new users (e.g., user who are not existing users of identified entity). For example, search engine 160 may match the extracted criteria and patterns and mark users as potential new users of a service or manufacturer. When the process of social behavior modeler is completed, search engine 160 may generate new search criteria which are again fed to search indexer 120. These search criteria which may be generated by social search input generator may be based on the features, sentiments, trends, patterns, and/or various other factors extracted by generating the virtual profiles of existing users using social media. New search criteria generated by social search input generator 164 may ensure that the new search entities do not overlap with the existing records (e.g., records already fetched from the customer relationship management).

In step 235, system 100 may establish a communication medium to reach the identified potential customers. In an embodiment, after searches for new users are completed based on existing user criteria and trends, system 100 may store the results in storage layer 180 for identified entities or businesses to use. Since the potential new users who have been identified across social media and the Internet are similar to that of existing users provided by customer relationship management systems (e.g., in terms of behavior and/or activities), the potential new users may be tagged as potential customers for an identified business entity.

In step 240, system 100 may facilitate contacting the potential new users. In an embodiment, system 100 may utilize external resources 102 or output interface 190 to automatically contact new potential users. For example, output interface may send automated emails to new potential customers. The emails may be customized for each potential new user based on their profile information. The style and content may be customized, for example. Based on the user profile, system 100 may determine whether to include a discount in the contact email and, if so, how big of a discount to make. For example, based on the user profile, system 100 may determine that the user only needs a slight discount (e.g., 10%) to likely convert the potential customer. In other instances, the profile information and corresponding trends may indicate that a particular potential new user may hold out for larger discounts. System 100 may time and adjust offers accordingly.

In another embodiment, an entity may choose to contact the identified users directly. System 100 may provide available contact details crawled from social media to an entity using output interface 190. For example, system 100 may export a digitized list of email addresses and/or telephone numbers from storage layer 180 to an entity. The entity may utilize the contact information to reach new potential users. The medium of communication to use to reach these potential customers depends on the identified business rationales and/or user behavior. For example, a user profile may indicate that phone calls are more effective in influence that user's behavior than email.

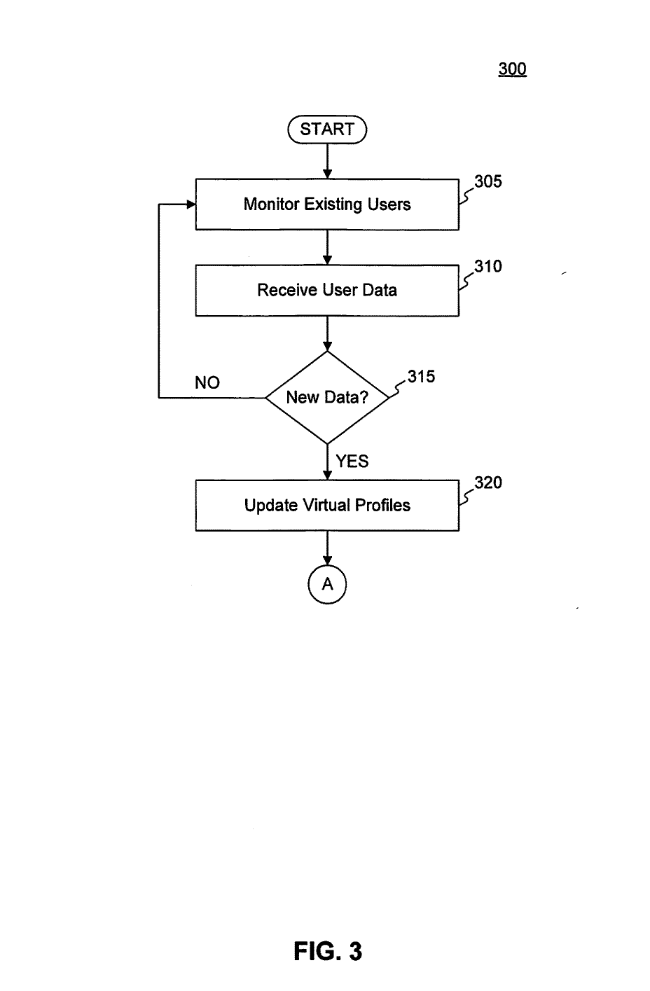

FIG. 3 is a flow diagram illustrating an exemplary update process in accordance with some embodiments of the present disclosure. The steps of process 300 are illustrated and listed in a particular order. However, this order is not meant to be limiting. For example, steps may be performed in other orders consistent with the disclosure. Further, various steps may be omitted in certain embodiments.

Process 300 may update user profiles based on new information gathered about the users. Beginning at step 305, internet listener 130 may initiate social media listeners and general monitoring for existing users (e.g., users with a profile). These listeners may receive updates when a user may make a new status update or blog entry, for example.

In step 310, internet listener 130 may receive streams of data. The data may be filtered into information related to existing profiles. For example, internet listener 130 may query storage layer 180 or virtual profile generator 150 to determine whether a profile exists for a user that uploaded a post from a known account. When the data does pertain to an existing user profile, system 100 may determine whether the additional information is new information or redundant to the profile record (step 315). For example, many internet websites provide copies of originally posted content (e.g., search engine caches, mirror websites, retweeting, shared status updates). Because the information may be already recorded in a profile, the data may not provide new information (step 315, “NO”). Therefore, there is no need to update the profile with the preexisting information, and system 100 may continue to monitor existing user profiles (step 305). When the information has not been previously recorded (step 315, “YES”), system 100 may update the virtual profile. Because the new information in the profile may give rise to additional trends, the multidimensional trend analysis may be repeated using the updated profiles (step 220). Thus, as new information is gathered on existing user profiles, system 100 may adapt to make use of current trends. Therefore, system 100 may continually create new leads on potential new users using new information about existing users.

FIG. 4 is a block diagram of an exemplary computer system for implementing embodiments consistent with the present disclosure. Variations of computer system 401 may be used for implementing input handler 110, search indexer 120, internet listener 130, virtual profile generator 150, behavior modeler 140, search engine 160, metadata configurator 170, storage layer 180, output interface 190, and external resources 102. Computer system 401 may comprise a central processing unit (“CPU” or “processor”) 402. Processor 402 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, external resources 102, data learning engine 162, search indexer 120, and storage layer 180.

The memory devices may store a collection of program or database components, including, without limitation, an operating system 416, user interface 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. (e.g., social media data, virtual profiles, trend analysis results, user contact information) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described systems and methods for identifying new users using trend analysis. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for identifying potential users using machine learning, comprising:
receiving, via one or more hardware processors, existing user data for a business entity;
identifying, via the one or more hardware processors, using the existing user data, account information of existing users on one or more social media networks;
configuring, via the one or more hardware processors, one or more social media listeners to extract, using the account information of the existing users, social media data associated with the existing users from the one or more social media networks;
creating, via the one or more hardware processors, virtual profiles for the existing users based on the existing user data and the social media data associated with the existing users;
extracting, by performing multidimensional trend analysis via the one or more hardware processors, one or more trends based on the virtual profiles and one or more requirements of the business entity; and
identifying, using a learning model implemented via the one or more hardware processors, based on the one or more extracted trends, new potential users using the social media networks.

2. The method of claim 1, further comprising:
tagging, via the one or more hardware processors, the new potential users as potential customers in a database.

3. The method of claim 1, further comprising:
querying, via the one or more hardware processors, the one or more social media networks to determine contact information for one of the new potential users; and
generating, via the one or more hardware processors, a communication to that new potential user using the contact information.

4. The method of claim 1, wherein the social media listener extracts the social media data associated with the existing users from the one or more social media networks over a predetermined period of time at a predetermined interval.

5. The method of claim 4, further comprising:
updating, via the one or more hardware processors, the virtual profiles for the existing users for the duration of the predetermined period of time;
extracting, by performing multidimensional trend analysis via the one or more hardware processors, one or more updated trends based on the updated virtual profiles; and
identifying, using the learning model implemented via the one or more hardware processors, based on the one or more updated trends, additional new potential users using the social media networks.

6. The method of claim 1, wherein the one or more social media listeners utilize one or more application programming interfaces of the one or more social media networks to receive real-time social media data for the existing users.

7. The method of claim 1, wherein:
the virtual profiles include tags indicating one or more interests, behaviors, and emotions associated with the existing users; and
the one or more trends are based on a frequency of one or more of the tags in the virtual profiles.

8. A user trend analysis system comprising:
one or more hardware processors; and
a computer-readable medium storing instructions that, when executed by the one or more hardware processors, cause the one or more hardware processors to perform operations comprising:
receiving, via one or more hardware processors, existing user data for a business entity;
identifying, via the one or more hardware processors, using the existing user data, account information of existing users on one or more social media networks;
configuring, via the one or more hardware processors, one or more social media listeners to extract, using the account information of the existing users, social media data associated with the existing users from the one or more social media networks;
creating, via the one or more hardware processors, virtual profiles for the existing users based on the existing user data and the social media data associated with the existing users;
extracting, by performing multidimensional trend analysis via the one or more hardware processors, one or more trends based on the virtual profiles and one or more requirements of the business entity; and
identifying, using a learning model implemented via the one or more hardware processors, based on the one or more extracted trends, new potential users using the social media networks.

9. The system of claim 8, the operations further comprising:
tagging, via the one or more hardware processors, the new potential users as potential customers in a database.

10. The system of claim 8, the operations further comprising:
querying, via the one or more hardware processors, the one or more social media networks to determine contact information for one of the new potential users; and
generating, via the one or more hardware processors, a communication to that new potential user using the contact information.

11. The system of claim 8, wherein the social media listener extracts the social media data associated with the existing users from the one or more social media networks over a predetermined period of time at a predetermined interval.

12. The system of claim 11, the operations further comprising:
updating, via the one or more hardware processors, the virtual profiles for the existing users for the duration of the predetermined period of time;
extracting, by performing multidimensional trend analysis via the one or more hardware processors, one or more updated trends based on the updated virtual profiles; and
identifying, using the learning model implemented via the one or more hardware processors, based on the one or more updated trends, additional new potential users using the social media networks.

13. The system of claim 8, wherein the one or more social media listeners utilize one or more application programming interfaces of the one or more social media networks to receive real-time social media data for the existing users.

14. The system of claim 8, wherein:
the virtual profiles include tags indicating one or more interests, behaviors, and emotions associated with the existing users; and
the one or more trends are based on a frequency of one or more of the tags in the virtual profiles.

15. A non-transitory computer-readable medium storing computer-executable trend analysis instructions for:
receiving, via one or more hardware processors, existing user data for a business entity;
identifying, via the one or more hardware processors, using the existing user data, account information of existing users on one or more social media networks;
configuring, via the one or more hardware processors, one or more social media listeners to extract, using the account information of the existing users, social media data associated with the existing users from the one or more social media networks;
creating, via the one or more hardware processors, virtual profiles for the existing users based on the existing user data and the social media data associated with the existing users;
extracting, by performing multidimensional trend analysis via the one or more hardware processors, one or more trends based on the virtual profiles and one or more requirements of the business entity; and
identifying, using a learning model implemented via the one or more hardware processors, based on the one or more extracted trends, new potential users using the social media networks.

16. The medium of claim 15, the instructions further comprising:
tagging, via the one or more hardware processors, the new potential users as potential customers in a database.

17. The medium of claim 15, the instructions further comprising:
querying, via the one or more hardware processors, the one or more social media networks to determine contact information for one of the new potential users; and
generating, via the one or more hardware processors, a communication to that new potential user using the contact information.

18. The medium of claim 15, wherein the social media listener extracts the social media data associated with the existing users from the one or more social media networks over a predetermined period of time at a predetermined interval.

19. The medium of claim 18, the instructions further comprising:
updating, via the one or more hardware processors, the virtual profiles for the existing users for the duration of the predetermined period of time;
extracting, by performing multidimensional trend analysis via the one or more hardware processors, one or more updated trends based on the updated virtual profiles; and
identifying, using the learning model implemented via the one or more hardware processors, based on the one or more updated trends, additional new potential users using the social media networks.

20. The medium of claim 15, wherein:
the virtual profiles include tags indicating one or more interests, behaviors, and emotions associated with the existing users; and
the one or more trends are based on a frequency of one or more of the tags in the virtual profiles.
